(19) United States
(12) Patent Application Publication
(10) Pub. No.: US 2006/0275712 A1
(43) Pub. Date: Dec. 7, 2006

(54) Method for fabrication of physical patterns and the method for fabrication of device using the same

(76) Inventors: Yumiko Anzai, Ome (JP); Toshimichi Shintani, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/209,649

(22) Filed: Aug. 24, 2005

(30) Foreign Application Priority Data
Jun. 2, 2005 (JP) 2005-162513

(51) Int. Cl. G03C 5/00

(52) U.S. Cl. 430/321; 430/945

(57) ABSTRACT

Etching properties are improved in a processing method of a phase change material in which the regions of one state are removed by etching to form a fine physical pattern. The phase change film is subjected to an advance treatment conducted before the etching, and this advance treatment uses water, an alkaline solution, an acid solution, or a surface-active agent. The regions to be removed by the etching are treated in the advance treatment to facilitate penetration of the etchant in the etching step so that complete removal is accomplished with no film residue. The advance treatment also improves etching resistance of the regions to be left unremoved. The process is thereby stabilized.

CROSS REFERENCE TO RELATED APPLICATION

U.S. Patent application No. 11/051,143 is a co-pending application of this application. The content of which is incorporated herein by cross-reference.

### CLAIM OF PRIORITY

The present application claims priority from Japanese Applications JP 2005-162513 filed on Jun. 2, 2005, the content of which is hereby incorporated by reference into this application.

### FIELD OF THE INVENTION

This invention relates to a method for forming a fine physical pattern.

### BACKGROUND OF THE INVENTION

Methods for imparting a material with a physical pattern by using the difference in physical or chemical properties between the region having an energy applied and the region having no such energy applied can be divided into two categories: those wherein the energy used is an optical energy and those wherein the energy used a thermal energy. In the field of semiconductors and optical disks, methods using an optical energy is generally known, and in such methods, the physical pattern is formed by forming a latent image on a resist deposited on the substrate by irradiating the resist with a laser beam or an electron beam (EB), developing the latent image for the removal of the part that has been irradiated or not irradiated with the beam. In either case, a finer pattern can be formed by reducing the spot diameter of the laser beam or the EB, and the spot diameter can be reduced by using a beam with shorter wavelength or by using an objective lens having a larger numerical aperture (NA). Use of ArF laser having a wavelength of 193 nm is currently developed, and this method has succeeded in fabricating a line with a width of about 100 nm.

With regard to the other methods, namely, the methods using a thermal energy for the pattern formation, ROM disk production using a thermal energy is proposed in Japanese Journal of Applied Physics 42, 769-771 (2003); JP-A No. 2005-11489; and Japanese Journal of Applied Physics 42, 769-771 (2003). In this method, the medium is irradiated with a laser beam to induce the change in some parts of the medium by the thermal energy generated through absorption of the light. Applied Physics Letters, Vol. 85, No. 4, 639-641 (2004) discloses that fine pits can be formed by utilizing the difference in the chemical properties between the crystalline state and the amorphous state, namely, by removing either the crystalline or the amorphous parts to thereby form the physical pattern.

### SUMMARY OF THE INVENTION

In the resist processing using an optical energy, reaction of the resist is proportional to the total amount of the beam such as laser beam that has been irradiated, and limitation is set on the preciseness of the processing. The situation is the same for the processing using an EB. Such limitation may be overcome if the amount of the beam irradiated were calculated in advance to thereby correctly regulate the power of the beam. Production of a high density pattern in this manner, however, requires use of an extremely low power. More specifically, energy of a beam is generally distributed in a concentric manner with the power rapidly reducing toward the periphery, and therefore, only an extremely limited portion near the center of the beam spot will be used in the production of such fine configuration, and the pattern formed significantly changes with the slight change in the beam power. That is, the power margin of the beam is extremely reduced. This invites poor reproducibility of the process as well as significant decrease in the yield of the pattern and the device.

The processing using thermal energy as described in Japanese Journal of Applied Physics 42, 769-771 (2003) and JP-A No.2005-11489, supra, are also limited for the preciseness of the processing since the size of the article processed by thermal energy is determined by the temperature threshold and power reduction is required for such precise processing. In such a case, only limited portion of the power at the tip of the beam will be used, and the power margin will be reduced as described above.

In the processing method and information recording medium described in Applied Physics Letters, Vol. 85, No. 4, 639-641 (2004), supra, in which the physical pattern is formed by selectively removing either the crystalline or the amorphous region to use optical properties of the remaining unetched region, the record marks formed will be small or narrow due to its production mechanism. Therefore, the removal of the etched region should be conducted in most efficient manner, and reliability and performance should be improved by leaving the surface of both the etched region and the unetched region as smooth as possible to thereby reduce the noise. As an experiment, RIN (Relative Intensity Noise) was measured for a commercial 4.7 GB DVD RAM disk and the 4.7 GB DVD RAM that has been treated in order to compare the surface smoothness. RIN is the noise standardized by reflectivity, and it was measured at a wavelength of 405 nm, an NA of 0.85, a linear velocity of 5 m/s, and a measurement frequency of 2 MHz. While the RIN of the commercial disk was −100 dB/Hz, the disk having the crystalline regions removed exhibited an increased noise with the RIN of −90 dB/Hz. In the observation using an electron microscope, the noise increase was found to be caused by the fine particles remaining on the surface in the area where the film had been dissolved in the etching. The dissolved region will be smooth if the etching was conducted for a longer time or at a high pH. However, the region to be left undissolved (amorphous region) will then become dissolved. As described above, it has been difficult to simultaneously satisfy both the surface smoothness and the selectivity.

In view of the situation as described above, an object of the present invention is to improve the etching process in the process of forming a fine physical pattern and reduce the maximum surface roughness (Rmax) of the surface of the physical pattern to the level of 3 nm or less to thereby enable further increase of the density. While average surface roughness (Ra) has been commonly used as a parameter for the surface roughness, maximum surface roughness (Rmax) has been found to exhibit good correlation to noise properties in the investigation of the present invention, and therefore, Rmax is used in the present invention for the index of the surface roughness.

Such an object may be accomplished by subjecting the phase change film to an advance treatment before the subsequent etching when a pattern comprising crystalline regions and amorphous regions is formed in the phase change film formed on a substrate, and the crystalline regions or the amorphous regions are selectively etched to form a physical pattern corresponding to the pattern formed by the crystalline and the amorphous regions. The advance treatment may be a treatment using water, an alkaline solution, an acid solution, or a surface-active agent. Alternatively, the advance treatment maybe accomplished by selectively forming a fluoride layer on the amorphous region of a phase change film.

When a physical pattern is formed by selectively etching the crystalline regions or the amorphous regions of the phase change film, the etching properties can be effectively improved if the surface is treated before such etching so that the regions to be removed by the dissolution and the regions to be left undissolved will have surface conditions different from one another. More specifically, when the regions to be removed by the dissolution are treated to increase the solubility of the region, and the regions to be left undissolved are treated to reduce the solubility of the region, the etching will be facilitated to leave a smooth surface in both the etched and unetched regions. The advance treatment of the present invention is a treatment capable of accomplishing such an effect, an it contributes for the stability of the process by reducing the etching time and by increasing the etching margin.

The present invention has enabled to reduce the maximum surface roughness of the etched region and the unetched region to the level of as low as 3 nm or less in the process of forming a fine physical pattern by selective etching, and such effect is realized by introducing a step of conducing a treatment for promoting the selective etching. More specifically, the present invention is effective in stabilizing the process since the etchant enters into the boundary between the layer subject to the physical pattern formation and the underlying layer to enable more thorough removal of the regions to be removed as well as increase in the etching resistance of the regions to be left.

Such improvement will enable provision of an excellent device with reduced roughness, for example, a high density information recording medium with reduced noise having a capacity of at least several hundred GB.

### BRIEF DESCRIPTION OF THE DRAWINGS

FIGS. 1A-1F show the production steps of a ROM substrate of an optical disk according to the present invention.

FIG. 2 shows change in the film thickness of the crystalline and the amorphous regions caused by the etching with an alkaline.

FIG. 3 shows the power modulation pattern of the laser beam used for recording the amorphous marks.

FIGS. 4A-4G explain the production of the disk structure using the unetched regions according to the present invention.

FIGS. 5A-5C explain other embodiments of the present invention. FIG. 5A shows an embodiment using reactive ion etching treatment, FIG. 5B shows an embodiment using an etching assistant layer, and FIG. 5C shows an embodiment using the post treatment.

FIGS. 6A-6E are views showing an embodiment of the device of the present invention.

### DETAILED DESCRIPTION OF THE PREFERRED EMBODIMENTS

Next, the embodiments of the present invention are described by referring to the drawings.

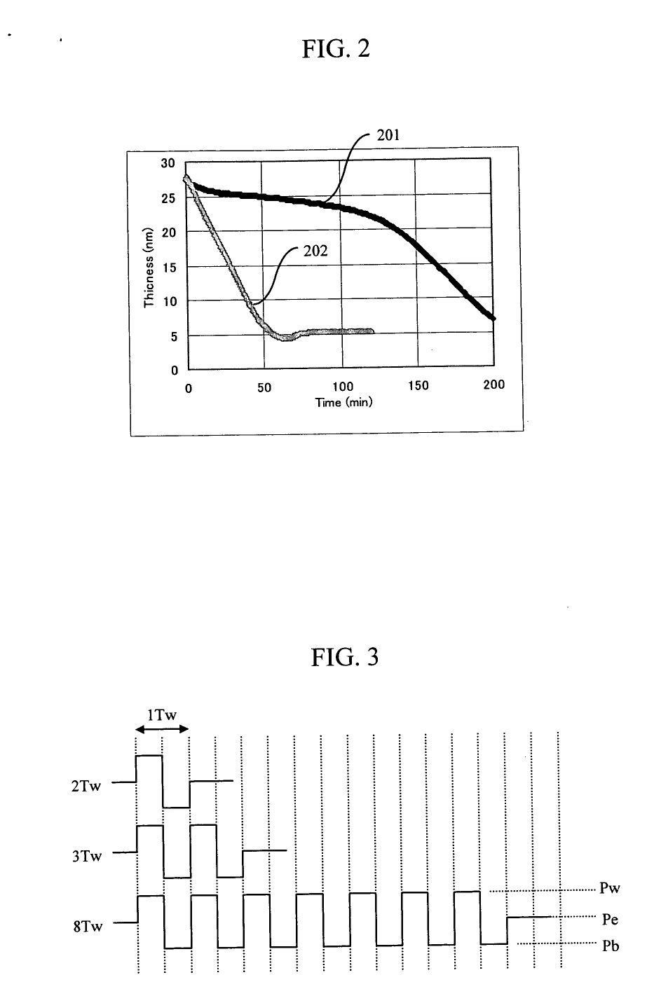

An exemplary material adapted for providing a physical pattern is a phase change material, and when an energy is applied to some regions of the material to leave the region having and not having the energy applied, and respective regions are subsequently converted into the etched and unetched regions, a physical pattern will be formed by the difference in the degree of etching between the crystalline and the amorphous regions. The difference in the solubility of the crystalline region and the amorphous region relates to the surface property. In the case of Ge₅Sb₇₀Te₂₅ which is a typical phase change material used in an optical disk, the crystalline region will become dissolved to leave the amorphous region undissolved. FIG. 2 shows the results of an experiment in which a sample having the structure of a glass substrate/an underlying layer/the Ge₅Sb₇₀Te₂₅ (30 nm) was immersed in an alkaline solution to measure the change in the film thickness of the crystalline and amorphous layers. In FIG. 2, curve 201 shows the change in the film thickness of the amorphous region and the curve 202 shows the change in the film thickness of the crystalline region. The graph demonstrates that the change in the film thickness is linear in the case of the crystalline region whereas the change proceeds in two stages in the case of the amorphous region.

The reason is estimated as described below. Since the etching of the amorphous region starts slow but gets faster at some point, both crystalline region and the amorphous region should be soluble in the solution while a layer having some etching resistance should be present on the surface of the amorphous region. In addition, while a film such as an oxide film may form on both the crystalline region and the amorphous region, if the material is in polycrystalline state and the sample is immersed in the etchant, the etchant will penetrate through the grain boundary to separate the crystal grains from one another. The surface in contact with the solution will then be increased, and the material will show an increased solubility in the solution.

If the etching proceeds along the grain boundary, an advance treatment may be conducted to facilitate the entrance of the etchant into the boundary, and subsequently, an etching treatment may be carried out to stably leave the amorphous region. Since the etching proceeds at a substantially same speed in both the crystalline and the amorphous regions if they are treated by a strong alkaline or a strong acid, the dissolution profile necessary for a selective etching would not be obtained by the use of such etchant. Therefore, an advance treatment is preferably conducted, for example, by a treatment with water, a treatment with a slightly strong alkaline (with a higher pH value), or a treatment with a slightly strong acid (with a lower pH value) to thereby utilize the hydrophilicity of the grain boundary, and if an alkaline or an acid is used, the treatment is preferably completed in a short time. The advance treatment may also be conducted by using the two or more solutions of the same type at different pH, for example, by treating the article with a relatively strong alkaline solution for a short time, and then treating the article with a weaker alkaline solution. When an alkaline surface-active agent is used, it will proceed along the grain boundary to form a film with a high etching resistance on the surface of the amorphous portion. The conditions used in the advance treatment may vary according to the phase change material used. The conditions, however, may be adequately determined by considering the desired change in the wetting property of the material realized by the advance treatment. For example, when the phase change film is a GeSbTe film, the surfaces of both the crystalline and the amorphous regions exhibit good wetting property before the advance treatment, and the contact angles of the droplets on the sample surfaces are as low as about 5 to 40 degrees and the surfaces are wettable. However, when these surfaces are adequately treated, wetting property of the surface of the crystalline region will be selectively reduced in short time and the droplet will then be repelled by the surface while the surface of the amorphous surface maintains its wetting property and the droplet will not be repelled by the surface. Tables 1 and 2 show conditions used in the advance treatment and the maximum surface roughness (Rmax) of the etched region (crystalline region) and the unetched region (amorphous region) after the etching for the case of a Ge₅Sb₇₀Te₂₅ film. The etching conditions were the same in all measurements, and the sample was immersed in an alkaline solution at pH 10.0 for 30 minutes.

The time of the advance treatment is featured by bold line for the case when some change in the wetting property was noted, and the Rmax under such conditions is indicated. The Rmax was measured by using an atomic force microscope (AFM) (cantilever length, 100 μm; k, 0.1 N/m) at a contact force of 1 nN. The area evaluated was 200 nm².

TABLE 1
Time of the advance treatment and maximum surface roughness
(Rmax)
(Crystalline surface)

| | | | | | | | | |
|---|---|---|---|---|---|---|---|---|
| Treatment time (min) | 0 | 0.5 | 1 | 2 | 5 | 10 | 30 | 60 |
| Water | 18.2 | 15.9 | 16.9 | 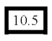 | 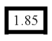 | 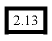 | 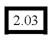 | 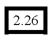 |
| pH 13 | 18.2 | 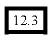 | 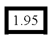 | 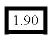 | 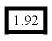 | 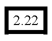 | 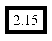 | 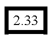 |
| pH 12 | 18.2 | 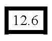 | 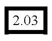 | 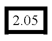 | 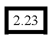 | 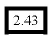 | 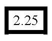 | 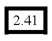 |
| pH 5 | 18.2 | 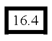 | 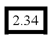 | 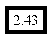 | 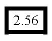 | 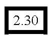 | 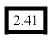 | 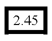 |
| pH 4 | 18.2 | 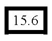 | 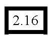 | 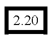 | 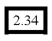 | 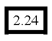 | 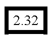 | 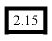 |
| Surface active agent + alkaline | 18.2 | 16.2 | 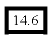 | 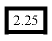 | 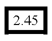 | 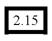 | 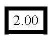 | 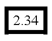 |

* Unit: nm

TABLE 2
Time of the advance treatment and maximum surface roughness
(Rmax)
(Amorphous surface)

| | | | | | | | | |
|---|---|---|---|---|---|---|---|---|
| Treatment time (min) | 0 | 0.5 | 1 | 2 | 5 | 10 | 30 | 60 |
| Water | 2.03 | 2.23 | 1.98 | 2.36 | 2.23 | 2.22 | 2.35 | 2.24 |
| pH 13 | 2.35 | 2.15 | 2.14 | 2.01 | 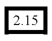 | 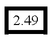 | 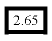 | 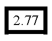 |
| pH 12 | 2.33 | 2.00 | 2.22 | 2.33 | 2.05 | 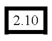 | 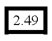 | 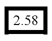 |
| pH 5 | 2.25 | 2.03 | 2.41 | 2.30 | 2.22 | 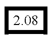 | 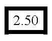 | 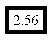 |
| pH 4 | 2.23 | 2.20 | 2.30 | 1.99 | 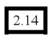 | 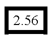 | 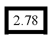 | 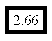 |
| Surface active agent + alkaline | 1.98 | 2.35 | 2.00 | 2.22 | 2.17 | 2.22 | 2.11 | 2.13 |

* Unit: nm

The surface of the crystalline region soluble to an alkaline exhibited a large Rmax when it was subjected to the advance treatment for 0 minute, indicating that the etching had been incomplete and the surface left was far from being smooth. When the advance treatment was stopped immediately after noticing the change in the wetting property of the surface of the crystalline region, the Rmax was still excessively large. However, when the etching was continued by using such wettability change as an index, the surface became smooth after further etching. In the advance treatments using pure water, an alkaline, an acid, and an alkaline solution containing a surface-active agent, wetting property of the surface of the crystalline region changed at 2 minutes, 30 seconds, 30 seconds, and 1 minute, respectively. When the advance treatment was continued, smooth surfaces with the Rmax of 3 nm or less were obtained in all of such treatments. In the meanwhile, the amorphous region which was left undissolved maintained its smooth surface as long as the advance treatment was conducted within such time range. However, the surface of the amorphous region also dissolved when it was treated with a stronger alkaline or a stronger acid and Rmax increased when the treatment was continued for a longer period while Rmax remained within acceptable range as long as the treatment was within 60 minutes. The film thickness started to change when the advance treatment was continued for 6 hours in the case of the pure water, 40 minutes in the case of the alkaline and the acid, and about 8 hours in the case of the alkaline solution containing the surface-active agent, and the advance treatment should not be continued for such a long time. Since a treatment for an excessively long time is undesirable in view of the process design, the advance treatment is preferably carried out for 1 minute to 90 minutes. When the advance treatment was conducted for an adequate time, change in the time course of the film thickness reduction was induced, and, compared to the results shown in FIG. 2, the reaction proceeded faster in the case of the crystalline region by 15 to 30%, and in the case of the amorphous region, the start of the film thickness change was delayed 3 to 4 times.

As described above, the advance treatment assists and promotes the etching in the formation of the fine physical pattern. More specifically, the regions to be dissolved become more soluble and the regions to be left gain higher etching resistance by the advance treatment, and-efficient formation of the physical pattern is thereby enabled. For example, selective etching will be facilitated if the surface of the amorphous region to be left is subjected to an advance treatment which forms a film such as an oxide film and the crystalline region to be removed is subjected to an advance treatment which facilitates penetration of the etchant through the grain boundary to the boundary with the underlying layer to promote the separation of the phase change film from the underlying layer. As a result of such advance treatment, the maximum surface roughness of the crystalline and the amorphous regions can be reduced to the level of 3 nm or less. In particular, the etchant that has proceeded to reach the boundary between the phase change film and the underlying layer facilitates complete removal of the part to be removed and full exposure of the underlying film with no film residue remaining on its surface.

Not only the crystalline and the amorphous regions, but also other regions having different structure or morphology (for example, the regions to which a thermal energy has been applied and not applied, or the regions having the thermal energy applied under different conditions) can experience different degree of etching, and hence, formation of a physical pattern, and this implies that similar effects will be obtained if the material employed is the one which undergoes structural change by the application of a thermal energy or by changing the condition of the thermal energy application. When the surface conditions are different by the type of the material employed, equivalent effects may be obtained by adjusting the time of the advance treatment, concentration of the etchant, time of the etching, and the like. The combination and the conditions of the advance treatment and the etching method should also be adjusted according to the material employed. For example, if a GeSbTe phase change film is employed as in the case of the above example but the one employed has the composition of Ge₂Sb₂Te₅, the alkaline solution should be adjusted to pH 13.0 in order to complete the etching of the film having the same thickness in the same time. As demonstrated by this example, the conditions employed in the etching may be changed to match the material when a different material is employed. Tables 3 and 4 show conditions used in the advance treatment and the maximum surface roughness (Rmax) of the etched region (crystalline region) and the unetched region (amorphous region) after the etching for the case of a Ge₂Sb₂Te₅ film. The etching conditions were the same in all measurements, and the sample was immersed in an alkaline solution at pH 13.0 for 30 minutes.

TABLE 3
Time of the advance treatment and maximum surface roughness
(Rmax)
(Crystalline surface)

| | | | | | | | | |
|---|---|---|---|---|---|---|---|---|
| Treatment time (min) | 0 | 0.5 | 1 | 2 | 5 | 10 | 30 | 60 |
| Water | 17.6 | 16.0 | 16.7 | 10.5 | 1.85 | 2.13 | 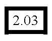 | 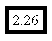 |
| pH 14.5 | 17.6 | 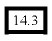 | 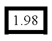 | 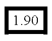 | 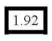 | 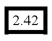 | 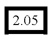 | 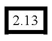 |
| pH 13.5 | 17.6 | 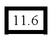 | 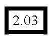 | 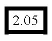 | 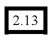 | 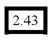 | 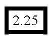 | 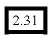 |
| pH 4.5 | 17.6 | 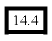 | 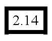 | 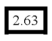 | 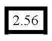 | 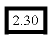 | 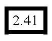 | 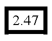 |
| pH 3.5 | 17.6 | 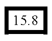 | 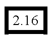 | 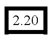 | 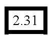 | 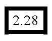 | 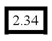 | 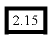 |
| Surface active agent + alkaline | 17.6 | 16.0 | 14.6 | 2.25 | 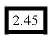 | 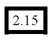 | 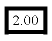 | 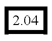 |

* Unit: nm

TABLE 4
Time of the advance treatment and maximum surface roughness
(Rmax)
(Amorphous surface)

| | | | | | | | | |
|---|---|---|---|---|---|---|---|---|
| Treatment time (min) | 0 | 0.5 | 1 | 2 | 5 | 10 | 30 | 60 |
| Water | 2.03 | 2.25 | 2.14 | 2.16 | 2.23 | 2.22 | 2.35 | 2.24 |
| pH 14.5 | 1.98 | 2.05 | 2.17 | 2.31 | 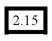 | 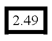 | 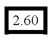 | 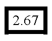 |
| pH 13.5 | 2.00 | 2.20 | 2.12 | 2.27 | 2.05 | 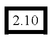 | 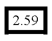 | 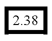 |
| pH 4.5 | 2.05 | 2.13 | 2.40 | 2.20 | 2.22 | 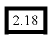 | 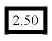 | 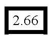 |
| pH 3.5 | 2.18 | 2.20 | 2.30 | 2.00 | 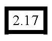 | 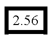 | 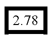 | 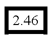 |
| Surface active agent + alkaline | 2.00 | 2.35 | 2.04 | 2.12 | 2.27 | 2.24 | 2.51 | 2.12 |

* Unit: nm

Next, embodiments of physical pattern formation are described.

### First Embodiment

A ROM substrate for an optical disk was produced by using a phase change film which is used in most optical disks by the method as described above.

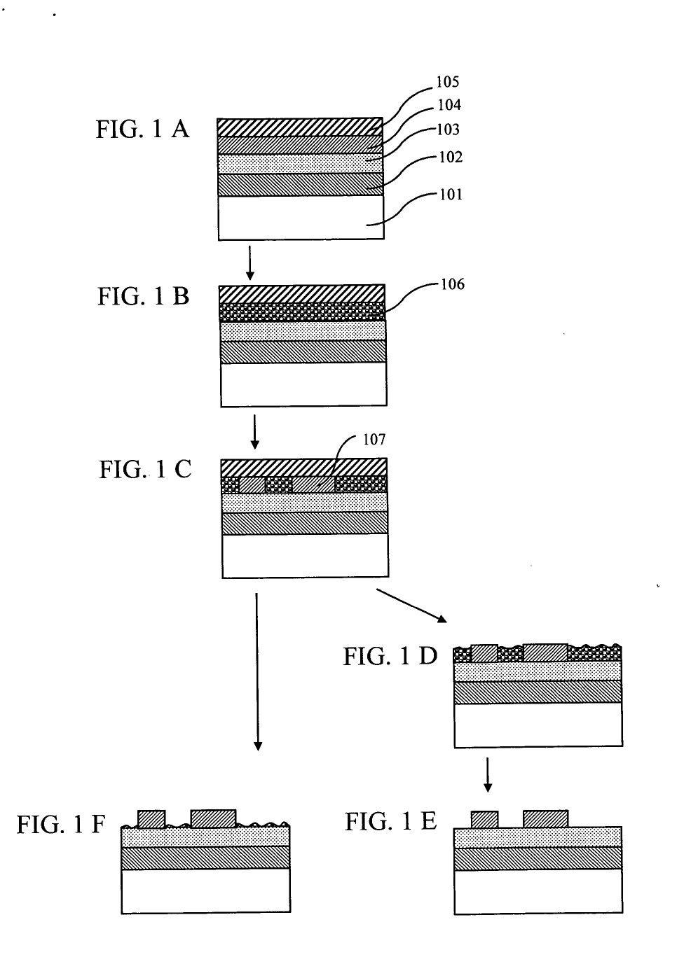

A medium having the structure of FIG. 1A was produced, and, an attempt was made to record amorphous marks by irradiating the medium with a laser beam. The medium comprises a glass substrate 101, and an Ag film 102, a lower protective film 103, a phase change film 104, and a protective film 105 disposed on the substrate 101 in this order. All of the film layers formed on the glass substrate 101 were formed by sputtering. The protective film 105 was formed from SiO₂, and the lower protective film 103 was formed from (ZnS)₈₀(SiO₂)₂₀, and the phase change film 104 was formed form Ge₅Sb₇₀Te₂₅. The Ag film 102 was formed to diffuse the heat generated within the phase change film by the laser irradiation.

This medium was heated in a bake furnace to a temperature of 300° C. for 3 minutes to crystallize the phase change film 104 into crystalline state 106 as shown in FIG. 1B. The phase change film of the medium in this state was irradiated by a laser beam having a wavelength of 400 nm directed through an objective lens having a numerical aperture of 0.9 to locally melt the phase change film by the irradiation and form the amorphous marks. For recording the marks, 1-7 modulation code at a window width Tw of 74.5 nm, the shortest mark of 2 Tw, and the longest mark of 8 Tw was used. The power of the laser beam used for the recording is modulated as shown in FIG. 3, and the pulse number is changed depending on the length of the mark to be recorded. The levels of the power used, namely, Pw, Pe, and Pb were respectively 7.0 mW, 3.5 mW, and 0.3 mW. The phase change film that had been crystallized were locally molten under such conditions, and the amorphous mark pattern 107 was recorded as shown in FIG. 1C. The protective film 105 was then etched by reactive ion etching (RIE) to expose the phase change film.

After such etching, the medium was placed on a spin coater, and the medium was rotated while pure water was added dropwise onto the medium at a position near the center of the medium so that the pure water would flow on the surface of the medium from its interior to the exterior. After 30 minutes, addition of the pure water was stopped (FIG. 1D), and NaOH solution at pH 10.5 was added dropwise for 30 minutes. The medium was then washed by adding pure water dropwise to the medium and dried by spinning. As a result of the procedure as described above, the crystalline regions of the phase change film became selectively dissolved to leave the amorphous regions as shown in FIG. 1E. Physical patterns could then be confirmed by the observation with a scanning electron microscope (SEM) or the measurement with an AFM. The maximum surface roughness (Rmax) of the etched surface and unetched surfaces measured with the AFM was 1.86 nm (etched region) and 2.03 nm (unetched region). Polycarbonate ROM substrates were then produced by using the sample of FIG. 1E for the master disk.

For comparison purpose, the physical pattern as shown in FIG. 1F was produced by the following procedure. After the recording of the pattern 107 in the phase change film as shown in FIG. 1C, the protective film 105 was etched by RIE to expose the surface of the phase change film, and without conducting the advance treatment of the dropwise addition of the pure water as shown in FIG. 1D, NaOH solution at pH 10.5 was added dropwise for 30 minutes to produce the physical pattern as shown in FIG. 1F. In this case, the maximum surface roughness was 18.5 nm because of the incomplete film removal in the etched region. Polycarbonate ROM substrates were then produced by using the sample of FIG. 1E for the master disk.

Ag reflective film was deposited on both the ROM substrate of the present invention and the ROM substrate of the Comparative Example, and the disks were evaluated for the RIN on a disk evaluator. The RIN was −90 dB/Hz in the case of the ROM substrate produced by the comparative method without conducting the advance treatment whereas it was −100 dB/Hz in the case of the ROM substrate of the present invention.

### Second Embodiment

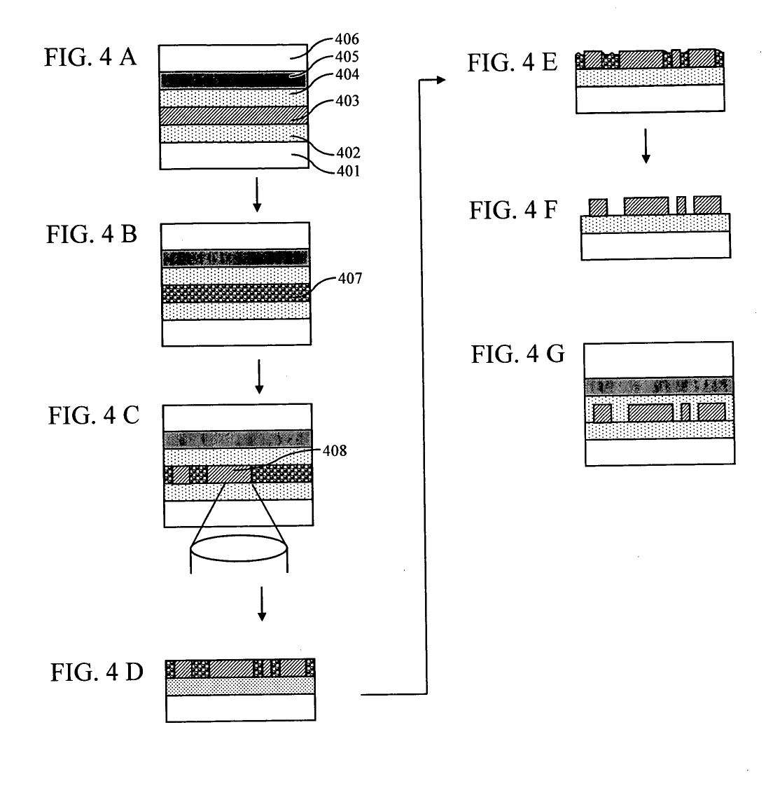

Another method for producing a physical pattern is shown in FIG. 4. In this method, a plastic substrate was used and the recording was accomplished by using a commercially available recording system. A polycarbonate substrate was used for the plastic substrate. As shown in FIG. 4A, a disk comprising a lower protective film 402, a phase change film 403, a upper protective film 404, a reflective film 405, and a polycarbonate upper substrate 406 disposed on a lower substrate 401 was produced. The films were all formed by sputtering, and the reflective film 405, the upper protective film 404, the phase change film 403, and the lower protective film 402 were deposited on the upper substrate 406 in this order. The reflective film 405 was an Ag film having a thickness of 20 nm, and the upper protective film 404 was a film of ZnS—SiO₂ having a thickness of 30 nm. The phase change film 403 was a film of Ge₅Sb₇₀Te₂₅ having a thickness of 20 nm, and the lower protective film 402 was a film of SiO₂ having thickness of 55 nm. The lower substrate 401 was a polycarbonate sheet having a thickness of 0.1 mm, and this sheet was adhered by using an ultraviolet curable resin.

As shown in FIG. 4B, the phase change film of this disk was crystallized by using an initializer for a phase change disk to form the crystalline film 407. The initializer uses a laser beam of 830 nm, and an objective lens with a NA of 0.5. Amorphous mark pattern 408 was then recorded as shown in FIG. 4C by using a commercially available recording system (wavelength 405 nm, objective lens with a NA of 0.85) to complete the disk.

In the etching, the disc was separated by peeling at the boundary between the upper protective film 404 and the phase change film 403 to realize the state of FIG. 4D. In this disk, the upper protective film comprising SiO₂ was provided to facilitate easier exposure of the recording film surface. The upper protective film 404 may be formed from a material other than SiO₂, and any desired film that is readily peeled from the phase change film may be selected. The disk was then subjected to the advance treatment by placing the disk on a spin coater, and the disk was rotated while pure water was added dropwise onto the disk at a position near the center of the disk so that the pure water would flow on the surface of the disk from its interior to the exterior. After 30 minutes, addition of the pure water was stopped (FIG. 4E), and NaOH solution at a pH of 10.5 was added dropwise for 30 minutes. The disk was then washed by adding pure water dropwise to the disk and dried by spinning. As a result of the procedure as described above, the crystalline regions of the phase change film became selectively dissolved to leave the amorphous regions and to form the physical pattern as shown in FIG. 4F. The maximum surface roughness (Rmax) of the etched surface and unetched surfaces measured with the AFM was 2.06 nm (etched region) and 2.35 nm (unetched region). Next, the upper protective film and the reflective film were formed again by sputtering on the substrate formed with the physical pattern, and the substrate was adhered using a UV curable resin to complete the disk structure (FIG. 4G). In this case, the protective film can be formed to separate and isolate the unetched regions of the phase change film formed by etching.

The thus produced disk was evaluated for the RIN. The PIN was −90 dB/Hz in the case of the conventional disk produced with no advance treatment of FIG. 4E in which the etching was incomplete, whereas it was −100 dB/Hz in the case of the disk of the present invention. The results confirmed that the etching was complete in the method of the present invention with no residue of the crystalline region remaining in the etched region.

When thickness of the lower substrate 401 is 0.1 mm or less, the upper substrate 406 does not have to be formed from polycarbonate. In such as case, it is not so important that the upper substrate is transparent, but it is the good adhesion to the upper protective film and the high durability to the etching that are important.

### Third Embodiment

In this embodiment, the advance treatment was accomplished by reactive ion etching. The surface of the region having a thermal energy applied thereto and the surface having no such thermal energy applied, or the regions having the thermal energy applied under different conditions experienced different reactions when such surfaces were further treated by slow reactive ion etching at a low power.

A disk was produced by repeating the procedure of the second embodiment, and after exposing the phase change film on the surface, the surface was treated-by reactive ion etching (RIE). The RIE was conducted for 20 seconds at a power of 100 W by using CHF₃ for the gas.

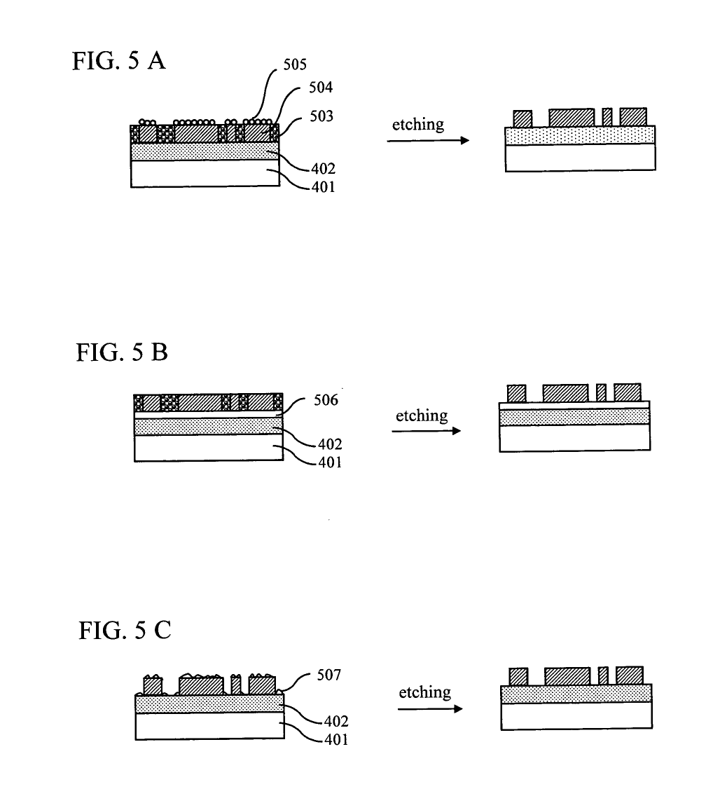

In order to evaluate the difference in the fluoride formation on the surface, a sample having a line-shaped amorphous region formed in the crystalline region was prepared and this sample was immersed in water. When it was removed from the water, the water was immediately shed by the crystalline region while it remained for some time on the amorphous region. The mechanism of the wetting by water of this embodiment is not the same as the embodiment as described above in which the film surface had been eroded by etching. The results indicate that there had been some difference in the formation of the fluoride layer 505 on the crystalline region 503 and the amorphous region 504, and the fluoride layer 505 had been selectively formed on the surface of the amorphous region as shown in FIG. 5A. When the sample was subsequently immersed in an alkaline solution at pH 10.5 for the etching of the crystalline region, a larger margin was allowed for the etching time. Since a fluoride generally has the nature of shedding the water, it is indicated that the fluoride layer was formed only on the amorphous region 504 to be left unetched and only the amorphous region 504 acquired the etching resistance. Since no fluoride layer was formed on the crystalline region 503, the dissolution occurred in this region as in the case of no RIE treatment. Since the region to be left unetched has acquired stronger etching resistance, use of an etchant having a stronger pH as well as a longer etching time were enabled. This in turn resulted in the reduced amount of the film residue and the smoother surface in the etched region.

### Fourth Embodiment

An embodiment of using an assistant layer (0.2 to 5 nm) for the underlying layer in the etching is described.

As shown in FIG. 5B, a sample having the structure similar to that of the first embodiment except for an assistant layer 506 formed between the lower protective film 402 and the phase change film 403 was formed. The assistant layer 506 formed was Co₃O₄ layer. The disk was recorded as in the case of the first embodiment, and etched by using an alkaline solution at pH 12.0 to thereby form the physical pattern. The resulting disk had smooth surface in both the etched and the unetched regions since the etched region had no unetched film residue. Next, a polycarbonate ROM substrate was formed by repeating the procedure of the first embodiment, and the disk was evaluated for the RIN on a disk evaluator to obtain the result of −100 dB/Hz which indicates that the etching had been completely accomplished without leaving any film residue.

When the region of the phase change material which has undergone a change brought by a higher thermal energy is to be left, a material having a higher melting temperature which only melts at a high temperature is preferably chosen for the assistant layer. The assistant layer will then play the role of an adhesive layer by the melting and it will also prevent the peeling by the etching. In the part which failed to reach the melting temperature, peeling occurs between the assistant layer and the phase change material and this facilitates the etching. In the case of such peeling, film residue is less likely to be left after the etching and the resulting surface will be smooth. The result will be more favorable when an advance treatment for promoting the peeling is conducted to facilitate the entrance of the etchant into the peeling interface. For example, in the case of the phase change material used in an optical disk, the amorphous region is formed in the cooling stage of the phase change material after the disk irradiation with a laser beam to locally melt the material with the heat generated by the absorption of the laser beam. The typical melting temperature is in the range of approximately 550° C. to 700° C. although the melting temperature may vary by the composition of the material. The typical crystallization temperature is in the range of 200° C. to melting temperature, and since the region that is to be left by the etching is the amorphous region, an assistant layer having a melting temperature which is close to the temperature of the amorphous phase formation is preferably selected. Materials such as CrO₃ and Bi₂O₃ are also useful. Sb₂O₃ and SeO₂ were presumed to be inadequate for use as an adhesive layer since they are susceptible to dissolution by water and acids. Their natures, however, changed by the mixing with the recording film, and they were also useful as an assistant layer.

### Fifth Embodiment

When the film residue remaining after the etching is an oxide, a post treatment for selective removal of such an oxide is also useful. When oxide 507 has been formed only on the bottom surface of the etched region and/or on the surface of the unetched region, such residue may be selectively removed by dry etching or wet etching as shown in FIG. 5C.

When the film residue is the one as shown in FIG. 1F and this film residue is identified to be an oxide, it may be removed by conducting the type of etching which only reacts with an oxide film, for example, by an RIE treatment using a gas such as CHF₃, C₂F₆, or CF₄ which is capable of selectively removing the oxide film residue. Such procedure is effective only when the film residue has been identified to be no longer the phase change material but a material different from the phase change material that had formed by the oxidation of some elements of the phase change material, and such selective etching of the film residue is possible since the film residue is different in its nature from the phase change material constituting the unetched region.

### Sixth Embodiment

A chip tray was formed by the method of the present invention.

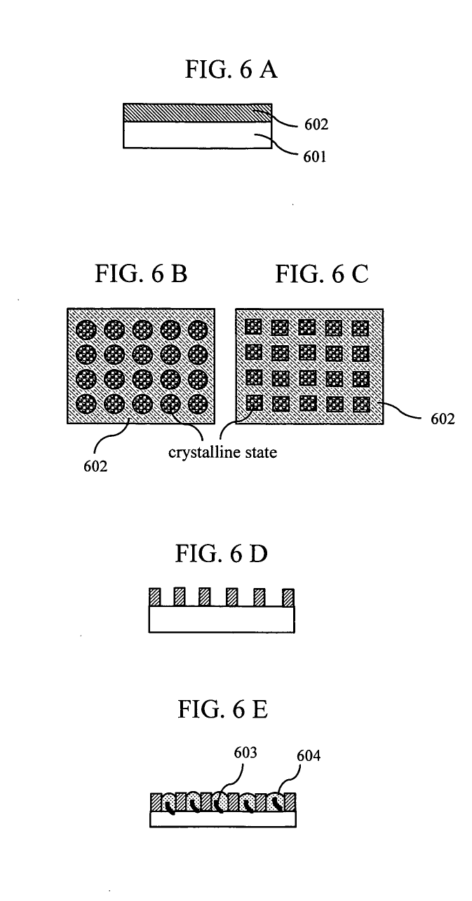

A sample having the structure of FIG. 6A was produced by forming a phase change film (amorphous) 602 on a glass substrate 601 by sputtering. The phase change film 602 used was a film of Ge₂Sb₂Te₅. A crystallization pattern as shown in FIG. 6B or 6C was formed in the phase change film 602 by irradiating the surface of the phase change film with a laser beam, and the sample was immersed in a solution at pH 4.0 for 2 minutes, washed with water, blown with air to blow away the water, and then etched by immersing in a solution at pH 13.0 for 30 minutes. As a consequence, the crystalline regions were removed to leave the physical pattern as shown in FIG. 6D. The thus formed etched and unetched regions comprise different materials from each other, and therefore, these regions have different wetting properties. For example, when they are compared in terms of contact angle with water, the surface of the phase change film has a contact angle with water of about 70 degrees while an oxide film like the SiO₂ film or the glass substrate has a contact angle with water of several degrees to about 20 degrees. In other words, the surface of the phase change film has poor wetting property and water is repelled by such surface while the region having the phase change film removed has a favorable wetting property, and the as a consequence, the water repelled would be all collected in the etched region. In the case of the chip tray, the surface having the phase change film removed should have a hydrophilicity higher than that of the phase change film, and an oxide film such as the one comprising SiO₂ may be formed as an underlying layer of the phase change film.

For example, when this sample is used as a biochip tray as shown in FIG. 6E, a probe 603 for a nucleotide sequence or a protein may be formed in each etched region as shown in FIG. 6D. In this step, different probes may be formed in each etched region, and this probe may be bonded to the substrate either by a covalent bond or by an ionic bond. Next, an analyte sample (specimen) such as blood is added dropwise to the substrate having the probes immobilized thereon. When the liquid specimen is added dropwise and shaken to some degree in various directions on the chip tray, the specimen 604 will be readily collected to the etched regions since they are repelled by the unetched regions due to the different wetting property of the etched and the unetched regions. The desired test is thereby accomplished. The specimen will be confined in each etched region with no contamination between the specimens of the adjacent etched regions, and a highly accurate detection of the reaction is thereby realized. Since the probes also have their own hydrophilicity, hydrophobicity, charge, and the like, alignment of the probes are also readily accomplished. Alignment of the biomolecules having different hydrophilicity, hydrophobicity, charge, and the like can also be accomplished by the use of such difference of the tray in the wetting property.

What is claimed is:

1. A processing method comprising the steps of:
forming a pattern of crystalline regions and amorphous regions in a phase change film formed on a substrate;
subjecting the phase change film to an advance treatment for etching; and
selectively etching the crystalline regions or the amorphous regions of the phase change film to form a physical pattern corresponding to said pattern formed by the crystalline and the amorphous regions.

2. The processing method according to claim 1 wherein said advance treatment is a treatment with water.

3. The processing method according to claim 1 wherein said advance treatment is a treatment with an alkaline solution.

4. The processing method according to claim 1 wherein said advance treatment is a treatment with an acid solution.

5. The processing method according to claim 1 wherein said advance treatment is a treatment with a surface active agent.

6. The processing method according to claim 1 wherein said advance treatment is a treatment wherein a fluoride film is selectively formed on the amorphous regions of the phase change layer.

7. The processing method according to claim 1 wherein said formation of the pattern of the crystalline and the amorphous regions is accomplished by laser beam irradiation.

8. The processing method according to claim 1 wherein said physical pattern comprises an etched region and an unetched region and the etched region and the unetched region respectively have a maximum surface roughness (Rmax) of up to 3 nm.

9. The processing method according to claim 1 wherein the phase change film comprises at least one member selected from Ge, In, Sb, and Te.

10. A method for producing a device having a fine physical structure on its surface comprising the steps of
forming a pattern of crystalline regions and amorphous regions in a phase change film formed on a substrate;
subjecting the phase change film to an advance treatment for etching; and
selectively etching the crystalline regions or the amorphous regions of the phase change film to form a physical pattern corresponding to said pattern formed by the crystalline and the amorphous regions.

11. The device production method according to claim 10 wherein said device is a master disk of an optical disk.

12. The device production method according to claim 10 wherein said physical pattern comprises an etched region and an unetched region, and the etched region and the unetched region in the physical pattern are different in their wetting property for an aqueous solution.

13. The device production method according to claim 10 wherein said advance treatment is a treatment with water.

14. The device production method according to claim 10 wherein said advance treatment is a treatment with an alkaline solution.

15. The device production method according to claim 10 wherein said advance treatment is a treatment with an acid solution.

16. The device production method according to claim 10 wherein said advance treatment is a treatment with a surface active agent.

17. The device production method according to claim 10 wherein a fluoride film is selectively formed on the amorphous regions of the phase change layer.

18. The device production method according to claim 10 wherein said formation of the pattern of the crystalline and the amorphous regions is accomplished by laser beam irradiation.

19. The device production method according to claim 10 wherein the etched region and the unetched region in the physical pattern have a maximum surface roughness (Rmax) of up to 3 nm.

20. The device production method according to claim 10 wherein the phase change film comprises at least one member selected from Ge, In, Sb, and Te.
